(19) United States
(12) Patent Application Publication
(10) Pub. No.: US 2007/0067397 A1
(43) Pub. Date: Mar. 22, 2007

(54) Systems and methods for sharing documents

(75) Inventor: Bao Q. Tran, San Jose, CA (US)

Correspondence Address: TRAN & ASSOCIATES, 6768 MEADOW VISTA CT., SAN JOSE, CA, 95135, US

(73) Assignee: AVAILABLE FOR LICENSING

(21) Appl. No.: 11/230,235

(22) Filed: Sep. 19, 2005

(51) Int. Cl. G06F 15/16

(52) U.S. Cl. 709/206

(57) ABSTRACT

Systems and methods are disclosed for sending an electronic mail (email) by selecting an attachment in a first file format, the attachment containing meta-data; generating a translated attachment without the meta-data; and sending the translated attachment with the email. Separately, the method can include selecting an attachment in a first file format; generating a translated attachment in a second file format; and sending the translated attachment with the email.

### BACKGROUND

The present invention relates to systems and methods for sharing documents.

The rapid adoption of computers has in turn driven the popularity of communications in the form of electronic mail (e-mail). In an e-mail system, communication is provided between two or more computer terminals. Each computer terminal includes software for sending and receiving e-mail which typically includes the ability to reply to and/or forward received e-mail messages. These terminals may be coupled through a public telephone network employing modems, through a LAN or WAN network, or some combination of the above. E-mail permits transmission of text. E-mail also permits attachments such as text or graphic files to be included or attached to an e-mail message.

Typically, an e-mail system is controlled by a central system. The central system may be a PC or mainframe or some other computing system. This central system serves to receive e-mail messages, and store them. When a user wishes to receive e-mail messages, the user logs onto the central system and retrieves any stored messages. Thus, a user is able to retrieve received e-mail messages from any site where the user has access to a computer terminal which can connect to the central computing system. An e-mail sender, therefore, does not have to know where the receiver is or will be when the receiver wishes to receive messages. Rather, a sender typically sends e-mail messages to a receiver's address, and the receiver can retrieve that message from any desired PC.

The email can contain attachments. However, users need to be careful of simply emailing documents to others as these documents can contain meta-data. For example, various Microsoft Office programs such as Word, Excel and PowerPoint store metadata. When the user distributes an Office document electronically, the document might contain information that the user may not want to share publicly, such as information designated as “hidden” or information that allows the user to collaborate on writing and editing the document with others, including Track Changes, Comments, and Send for Review.

A survey of Word documents available on the net found that many of them contain sensitive information. About 100,000 Word documents from sites on the web were sampled and every single one of them had hidden information. About half the documents gathered had up to 50 hidden words, a third up to 500 words hidden and 10% had more than 500 words concealed within them. The hidden text revealed the names of document authors, their relationship to each other and earlier versions of documents. Occasionally it revealed very personal information such as social security numbers. Also available was useful information about the internal network the document traveled through, which could be useful to anyone looking for a route into a network.

The problem of leaky Word documents is pervasive and anyone worried about losing personal information might want to consider using a different word processing program. Alternatively utility programs can be used to scrub information from Word documents or following Microsoft's advice about how to make documents safer. The extra information embedded in a document can also allow a virus to spring from an attachment.

### SUMMARY

In one aspect, systems and methods are disclosed for sending an electronic mail (email) by selecting an attachment in a first file format, the attachment containing meta-data; generating a translated attachment without the meta-data; and sending the translated attachment with the email.

In another aspect, the method can include selecting an attachment in a first file format; generating a translated attachment in a second file format; and sending the translated attachment with the email.

In yet another aspect, the method for sending an electronic mail (email) includes selecting an attachment in a first file format, the attachment containing meta-data; and generating a translated attachment without the meta-data and sending the translated attachment with the email after a single user command.

In yet another aspect, the method for sending an electronic mail (email) includes selecting an attachment in a first file format, the attachment containing meta-data; and generating a translated attachment in a second file format without the meta-data and sending the translated attachment with the email after a single user command.

Implementations of any of the above aspects may include one or more of the following. The selecting, generating and sending the attachment are performed in one “Send To” command. The selecting, generating and sending the attachment are performed completely within an email software. The generating and sending the attachment are performed in response to a single user command. The generating the translated attachment can be based on a second file format. The second file format can be specified as a preference in advance of sending the email. The formats for translation may be: PDF, Word, Word Perfect, Works, Rich Text Format, text, XML, HTML, Web page, Excel, Powerpoint; Visio; Paintbrush; Freelance; Draw; JPEG; TIFF; fax; compressed format and standard bit map formats. The attachment can be compressed. The process can provide version control for the attachment. One or more viruses or Trojan horse modules can be automatically removed from the attachment. The email software can be Microsoft Outlook or Mozilla Firefox. The process can parse the email to determine whether the email is secure. Potentially infected emails can be determined based on one or more of the following: an email from field, an email to field, and an email subject field. The process can examine whether a security policy exists. The security policy can specify one of: characteristics of potentially infected emails; characteristics of prohibited emails; characteristics of prohibited directory; characteristics of prohibited documents; characteristics of prohibited data; characteristics of prohibited recipients; security level authorization of senders. The security policy can be used to automatically inhibit the transmission of the email and/or the attachment(s).

Advantages of the systems and methods may include one or more of the following. The system is convenient to use as it removes unwanted metadata and/or convert file formats prior to sending through an email in one convenient user command such as clicking a “Send” button. The method can also reduce or eliminate spamming or transmission of viruses through a computer network. The system allows a user to relate all of the steps in avoiding virus infections and to save all of the information regarding each of the various steps in one convenient and easily accessible location. The system is also efficient and low in operating cost. It also is highly responsive to user demands.

Other advantages and features will become apparent from the following description, including the drawings and claims.

### BRIEF DESCRIPTION OF THE DRAWINGS

FIGS. 1-4 show exemplary processes for document or attachment email transmission.

Like reference numbers and designations in the various drawings indicate like elements.

### DESCRIPTION

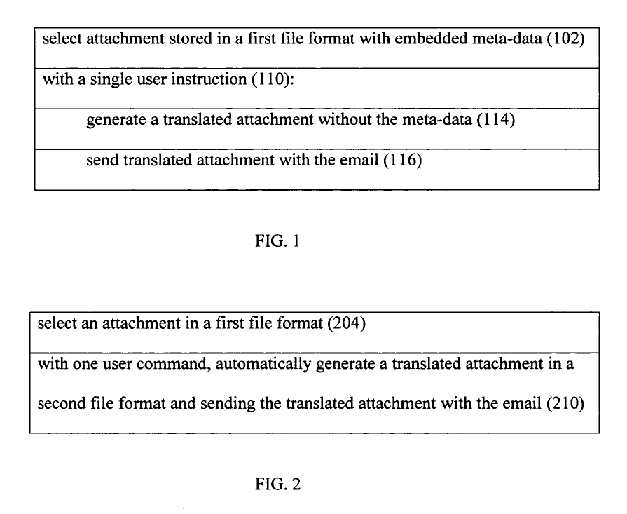

FIG. 1 shows a first aspect, for sending an electronic mail (email) with an attachment. The process includes selecting an attachment in a first file format where the attachment contains meta-data (102). Next, conveniently, a translation and a transmission of the translated attachment is done with only a single user instruction (110) that is then executed by the process as follows: the process generates a translated attachment without the meta-data (114) and sends the translated attachment with the email (116). Advantageously, the user does not need to invoke a utility to remove the meta-data with one user instruction and subsequently emails the cleaned file with another user instruction.

One implementation removes the following types of data from the attachment:
Comments.
Previous authors and editors.
User name.
Personal summary information.
Revision marks after accepting all revisions specified in the document.
Deleted text.
Versions.
Macros. Descriptions and comments are removed from macros such as Visual Basic modules.
The ID number used to identify the document for the purpose of merging changes back into the original document.
Routing slips.
E-mail headers.
Scenario comments.
Unique identifiers

The process of FIG. 1 allows the user to conveniently email in one command document(s) that is(are) free of hidden and collaboration data, such as change tracking and comments, from Word, Excel, and PowerPoint files, among others. Thus, personal or hidden data that might not be immediately apparent when the user views the document in his/her Microsoft Office application is removed when the user sends the document to a third party, such as an opposing party during a negotiation workflow.

FIG. 2 shows another aspect of the system. In this aspect, the process selects an attachment in a first file format (204); and with one user command, automatically generating a translated attachment in a second file format and sending the translated attachment with the email (210).

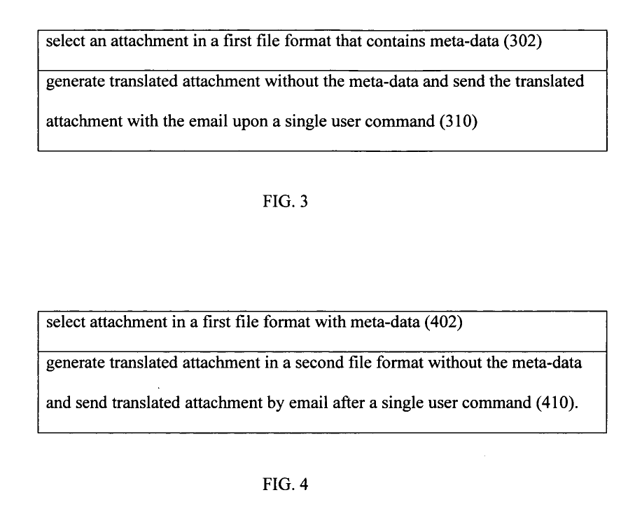

In yet another aspect shown in FIG. 3, the method for sending an electronic mail (email) includes selecting an attachment in a first file format and where the attachment contains meta-data as discussed above (302); and generating a translated attachment without the meta-data and sending the translated attachment with the email after a single user command (310).

In yet another aspect shown in FIG. 4, the method for sending an electronic mail (email) includes selecting an attachment in a first file format, the attachment containing meta-data (402); and generating a translated attachment in a second file format without the meta-data and sending the translated attachment with the email after a single user command (410).

In one embodiment, meta-data such as macro is removed to protect the user from sending potentially dangerous attachment such as a virus. If the user sends a document containing macros, the protective macros are activated and the user is alerted to the potential risk of opening files containing macros. The user is given the choice of sending the file without executing the macros If the sender overrides the recommendation, the receiver has a choice of opening the file as is, or canceling the file open operation. Opening the file without macros ensures that macro viruses are not transmitted and does not affect the content of the document.

The selecting, generating and sending the attachment are performed in one “Send To” command. The selecting, generating and sending the attachment are performed completely within an email software. The generating and sending the attachment are performed in response to a single user command. The generating the translated attachment can be based on a second file format. The second file format can be specified as a preference in advance of sending the email. The formats for translation may be: PDF, Word, Word Perfect, Works, Rich Text Format, text, XML, HTML, Web page, Excel, Powerpoint; Visio; Paintbrush; Freelance; Draw; JPEG; TIFF; fax; compressed format and standard bit map formats. The attachment can be compressed. The process can provide version control for the attachment. One or more viruses or Trojan horse modules can be automatically removed from the attachment. The email software can be Microsoft Outlook or Mozilla Firefox. The process can parse the email to determine whether the email is secure. Potentially infected emails can be determined based on one or more of the following: an email from field, an email to field, and an email subject field. The process can examine whether a security policy exists. The security policy can specify one of: characteristics of potentially infected emails; characteristics of prohibited emails; characteristics of prohibited directory; characteristics of prohibited documents; characteristics of prohibited data; characteristics of prohibited recipients; security level authorization of senders. The security policy can be used to automatically inhibit the transmission of the email and/or the attachment(s).

In one implementation, the system receives as input a file in one any of the following: HTML, RTF (MS Word doesn't need to be installed), XLS (MS Excel Worksheet), TXT (ANSI and Unicode), DOC (Word 6.0/95/97-2003, Asian Versions 6.0/95), WRI (Windows Write), WPD (WordPerfect 5.x/6.x/4.114.2), WK1, WK3, WK4(Lotus 1-2-3), MCW (Word for Macintosh 4.0-5.1), WPS (Works 4.0 for Windows, Works 2000, Works for Windows 3.0), DOC (Word 2.x for Windows, Word 3.x-5.x for MS-DOS, Word 6.0 for MS-DOS), SAM (Ami Pro 3.0), WSD (WordStar for Windows 1.0-2.0, WordStar 3.3-7.0), dBase (FoxPro/dBASE), RFT (IBM's RFT-DCA), PWI (InkWriter/Note Taker), PSW (Pocket InkWord Document), PDT (InkWriter/Note Taker Template), PWD (Pocket Word Document), PWT (Pocket Word Template), Clipboard, Lexicon for DOS, and generates an attachment in the form of PDF (doesn't require Adobe Acrobat to be installed), HTML, CHM, RTF (MS Word doesn't need to be installed), HLP, TXT (ANSI and Unicode), DOC (Word 6.0/95/97-2003), WRI (Windows Write 3.0/3.1), WPD (WordPerfect 5.0/5.1 for DOS/5.x for Win/5.1-5.2 secondary, 5.0 secondary, WordPerfect 4.1/4.2), MCW (Word for Macintosh 4.0-5.1), WPS (Works 4.0 for Windows, Works 2000, Works for Windows 3.0), DOC (Word 2.x for Windows, Word 3.x-5.x for MS-DOS, Word 6.0 for MS-DOS), SAM (Ami Pro 3.0), WSD (WordStar 4.0/7.0), RFT (IBM's RFT-DCA), PWI (InkWriter/Note Taker), PSW (Pocket InkWord Document), PWD (Pocket Word Document), among others.

In one implementation, the user can be in a document such as a Word document or an Excel spreadsheet and if the user wishes to send the document, he or she would click on the File menu, point to “Send to” and click “Mail recipient” and select “Send as is” or “Select file format.” If the user wishes to send the document with the meta data, he/she would select “Send as is” and otherwise the user selects the file format to be translated, for example PDF. Upon receiving the format command, the system invokes an email software with the attachment embedded thereto. In another implementation, when the user clicks “Mail recipient” in the above sequence, the system uses a previously selected file format and automatically translates the document into a desired format for the user. Thus, for example, if the user's history indicates that he/she prefers to convert Word documents into PDF documents for emails, the system automatically invokes such conversion prior to displaying an email send screen.

In one embodiment, the system extends Microsoft Outlook software, published by Microsoft Corporation of Redmond, Washington. The Outlook client application is divided into several modules, including a calendar manager, a task list manager, a contact manager, a message manager (e-mail), and a notes manager. All folders (containers) contain objects, or items such as e-mail items, appointment items, task items, address items, etc. Items have a set of fields and a behavior associated with them. For example, an e-mail item has To, From, CC, Subject, date and time fields among others. The behavior of e-mail items includes knowledge of what it means to Forward or Reply/Reply All. In this embodiment, the user would:

1. On the File menu, point to New, and then click Mail Message.

2. Enter recipient names in the To, Cc, and Bcc boxes. To select recipient names from a list, click the To, Cc, or Bcc button.

3. In the Subject box, type the subject of the message.

4. In the text box, type the message.

5. When the user clicks on the “Insert file” button, a UI is displayed that allows the user to browse/select a file along with options such as “Send as is” or “Select file format.” If the user wishes to send the document with the meta data, he/she would select “Send as is” and otherwise the user selects the file format to be translated, for example PDF. Upon receiving the format command, the system attaches the document to the email.

5. Click Send.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

The invention has been described in terms of particular embodiments. Other embodiments are within the scope of the following claims. For example, the steps of the invention can be performed in a different order and still achieve desirable results.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for sending an electronic mail (email), comprising:
selecting an attachment in a first file format, the attachment containing meta-data;
generating a translated attachment without the meta-data; and
sending the translated attachment with the email.

2. The method of claim 1, wherein the selecting, generating and sending the attachment are performed in one “Send To” command.

3. The method of claim 1, wherein the selecting, generating and sending the attachment are performed completely within an email software.

4. The method of claim 1, wherein the generating and sending the attachment are performed in response to a single user command.

5. The method of claim 1, comprising generating the translated attachment based on a second file format.

6. The method of claim 5, comprising specifying the second file format as a preference in advance of sending the email.

7. The method of claim 5, comprising selecting one of the following formats for translation: PDF, Word, Word Perfect, Works, Rich Text Format, text, XML, HTML, Web page, Excel, Powerpoint; Visio; Paintbrush; Freelance; Draw; JPEG; TIFF; fax; compressed format and standard bit map formats.

8. The method of claim 1, comprising compressing the attachment.

9. The method of claim 1, comprising providing version control for the attachment.

10. The method of claim 1, comprising removing one or more viruses from the attachment.

11. The method of claim 1, wherein the email software is Microsoft Outlook.

12. The method of claim 1, comprising parsing the email to determine whether the email is secure.

13. The method of claim 1, wherein potentially infected emails are determined based on one or more of the following: an email from field, an email to field, and an email subject field.

14. The method of claim 1, further comprising determining whether a security policy exists.

15. The method of claim 14, wherein the security policy specifies one of:
characteristics of potentially infected emails; characteristics of prohibited emails; characteristics of prohibited directory; characteristics of prohibited documents; characteristics of prohibited data; characteristics of prohibited recipients; security level authorization of senders.

16. A method for sending an electronic mail (email), comprising:
selecting an attachment in a first file format, the attachment containing meta-data; and
generating a translated attachment without the meta-data and sending the translated attachment with the email after a single user command.

17. The method of claim 16, comprising generating the translated attachment based on a second file format selected from one of: PDF, Word, Word Perfect, Works, Rich Text Format, text, XML, HTML, Web page, Excel, Powerpoint; Visio; Paintbrush; Freelance; Draw; JPEG; TIFF; fax; compressed format; standard bit map formats.

18. The method of claim 16, comprising parsing the email to determine one of the following: whether the email is secure in accordance with a company policy and whether the email contains virus.

19. A method for sending an electronic mail (email), comprising:
selecting an attachment in a first file format;
generating a translated attachment in a second file format; and
sending the translated attachment with the email.

20. The method of claim 19, wherein the generating and sending the attachment are performed in response to a single user command.
